(19) United States
(12) Patent Application Publication
(10) Pub. No.: US 2025/0038564 A1
(43) Pub. Date: Jan. 30, 2025

(54) SOLAR POWERED BATTERY CHARGER

(71) Applicant: SIGNIFY HOLDING B.V., EINDHOVEN (NL)

(72) Inventors: SHUAIB AHMED, DELHI (IN); MANOJ KUMAR, MEERUT (UP) (IN); SUDHIR JANGRA, ROHTAK (IN); DEBASISH MUKHERJEE, NEW DELHI (IN)

(21) Appl. No.: 18/717,022

(22) PCT Filed: Dec. 12, 2022
(86) PCT No.: PCT/EP2022/085335

§ 371 Date: Jun. 6, 2024

(30) Foreign Application Priority Data
Dec. 16, 2021 (IN) 202141058707
Mar. 17, 2022 (EP) 22162713.6

(51) Int. Cl. H02J 7/35; H02J 7/00; H02M 3/158

(52) U.S. Cl. CPC H02J 7/35; H02J 7/0034; H02M 3/158; H02J 2207/20

(57) ABSTRACT

A battery charger (300, 400) disclosed herein includes a DC-to-DC converter (154) configured to receive input from a photovoltaic power source (212) and provide a charging current to an energy storage device (206) and a bootstrap circuit (302, 402) comprising a bootstrap capacitor (222) configured to prevent reverse current from the energy storage device (206) to the charging circuit. The battery charger (300, 400) also includes a control circuit (158) coupled to the bootstrap circuit (302, 402) and the DC-to-DC converter (154) and configured to operate the bootstrap circuit to charge the bootstrap capacitor (222) for a first time duration. The control circuit (158) is also configured to operate the push-pull DC-to-DC converter (154) in asynchronous mode after the first time duration to charge the energy storage device (206) and operate the push-pull DC-to-DC converter in synchronous mode when the charging current reaches a first current value.

### FIELD OF THE INVENTION

The present invention relates to energy storage devices (battery). Specifically, the invention relates to charging of energy storage devices using solar photovoltaic power.

### BACKGROUND OF THE INVENTION

Use of solar panels to generate power has increased in the past decade as technology has improved and cost has decreased. The power can be generated by installing photovoltaic (PV) modules on a house, or a building. The electricity produced by the solar panels is generally either used in the home or fed into the commercial electricity grid to which the house is connected.

With the increase in the use of renewable energy, power systems used to manage the renewable energy require many changes. In renewable energy systems, Maximum Power Point Tracking (MPPT) control for extracting a maximum power is employed to enhance low power generation efficiency of the solar systems. MPPT control checks output of PV module compares it to battery voltage then fixes what is the best power that PV module can produce to charge the battery and converts it to the best voltage to get maximum current into battery. It can also supply power to a DC load, which is connected directly to the battery.

The charging circuitry of the solar battery charger includes electronic circuitry for providing power to the electric storage device (battery). Typically, a N-channel FET (Field Effect Transistor) based push-pull transistor configuration is used in such circuitry for efficiency purposes. During start up, charging starts with smaller duty cycle. Since high side MOSFET (Metal Oxide Semiconductor FET) and low side MOSFET pulse width modulations (PWMs) are complementary, a small duty cycle for buck converter is a very large duty cycle for the boost converter. When the synchronous converter is operating in DCM (discontinuous conduction mode), a negative current may flow from the battery towards the PV panels. Since the ohmic resistance of the push-pull configuration is low, the resulting negative current could be very high, and it may be harmful to the charging circuitry. The negative current problem in the solar battery charger, referred also as ‘back boosting’, is prevented conventionally by a diode connected in series with the high-end switch of the push-pull configuration to the PV panel. However, the diode may account for higher power dissipation in the buck mode affecting the power efficiency. As an alternative mechanism, a Field Effect Transistor (FET) along with a FET OR-ing controller is provided as a replacement for the series diode. Other solutions such as operating the push-pull configuration in the asynchronous mode and charging a bootstrap capacitor by a standalone SMPS power supply are envisaged. However, these solutions are costly and have impact on the power efficiency of the buck converter.

### SUMMARY OF THE INVENTION

Embodiments of a battery charger and a method of battery charging is disclosed in the present specification. Specifically, the embodiments disclosed in the present specification relate to charging of energy storage devices using solar photovoltaic power.

The battery charger includes a DC-to-DC converter comprising a charging circuit and configured to receive an input from a photovoltaic power source. The DC-to-DC charger is also configured to provide a charging current to an energy storage device via the charging circuit. The battery charger further includes a bootstrap circuit comprising a bootstrap capacitor and configured to prevent reverse current from the energy storage device to the charging circuit during transition from of the DC-to-DC converter from idle state to the charging state.

In one embodiment, the bootstrap circuit includes a diode in series with a first capacitor connected between the photovoltaic power source and the energy storage device. The bootstrap circuit further includes a transistor switch coupled to the first capacitor and configured to provide a charging path from the energy storage device to the first capacitor. The transistor switch is coupled to the photovoltaic power source and configured to provide a second charging path to the energy storage device. In another embodiment, the bootstrap circuit includes a resistor and a capacitor connected in series between input terminal of the DC-to-DC converter and the bootstrap capacitor and configured to provide a charging path from a boost voltage to the bootstrap capacitor during the idle condition.

The battery charger also includes a control circuit coupled to the bootstrap circuit and the DC-to-DC converter and configured to charge the bootstrap capacitor for a first time duration (or to a first voltage value) when the DC-to-DC converter is in the idle state. The control circuit is further configured to operate the DC-to-DC converter in asynchronous mode after the first time duration to charge the energy storage device when the charging current is less than a first current value. The control circuit is also configured to operate the DC-to-DC converter in synchronous mode when the charging current reaches the first current value. In one embodiment, the first current value is about 60% of the rated current of the photovoltaic power source. In some embodiments, the DC-to-DC converter comprises a high-side transistor and a low-side transistor arranged in a push-pull transistor configuration.

For the first embodiment of the bootstrap circuit, the control circuit is configured to switch on the transistor switch for the first time duration when charging is to be initiated when the charger is in idle condition. In one example, the first duration is selected as 100 milliseconds. For the second embodiment of the bootstrap circuit, the control circuit is configured to operate the DC-to-DC converter in a boost mode to generate the boost voltage. In both embodiments of the bootstrap circuit, the control circuit is configured to operate the high-side transistor as a switch and the low-side transistor as a diode to provide rectifying action in the asynchronous mode. Similarly, the control circuit is configured to operate the high-side transistor and the low-side transistor as switches to provide rectifying action in the synchronous mode.

In accordance with another aspect of the present specification, a battery charging method is disclosed. The method of battery charging includes operating a bootstrap circuit when a DC-to-DC converter is in idle state to charge a bootstrap capacitor for a first time duration. In one embodiment, the step of operating the bootstrap circuit includes charging the bootstrap capacitor by switching on a transistor switch of the bootstrap circuit. In another embodiment, the step of operating the bootstrap circuit comprises charging the bootstrap capacitor by a boost voltage via a capacitor and a diode connected in series with the bootstrap capacitor.

The method further includes operating the DC-to-DC converter in an asynchronous mode after the first time duration to charge the energy storage device when the charging current is less than a first current value. The method also includes operating the DC-to-DC converter in synchronous mode when the charging current reaches the first current value. In one embodiment, the first time duration is about 100 milliseconds and wherein the first current value is about 60% of the rated current of the photovoltaic power source. The step of operating the DC-to-DC converter in an asynchronous mode includes operating a high-side transistor as a switch and a low-side transistor as a diode to provide rectifying action in the asynchronous mode. Similarly, the step of operating the DC-to-DC converter in an asynchronous mode comprises operating the high-side transistor and the low-side transistor as switches to provide rectifying action in the synchronous mode.

### BRIEF DESCRIPTION OF THE DRAWINGS

The invention will now be further elucidated by means of the non-limiting schematic drawings in which some features may not be to the scale for explanatory reasons. In the drawings:

FIG. 1 depicts a solar powered energy system with a battery charger in accordance with the present invention;

FIG. 1a is a block diagram of the power controller 106 of FIG. 1 illustrating a battery charger in accordance with the present invention;

FIG. 2 depicts a conventional battery charger circuit used in the power controller;

FIG. 3 depicts a first embodiment of the bootstrap circuit used in the battery charger of FIG. 1 in accordance with the present invention;

FIG. 3a and FIG. 3b depict the operation of the bootstrap circuit of FIG. 3 in accordance with the present invention;

FIG. 4 depicts a second embodiment of the bootstrap circuit used in the battery charger of FIG. 1 in accordance with the present invention;

FIG. 4a, and FIG. 4b depict the operation of the bootstrap circuit of FIG. 4 in accordance with the present invention;

FIG. 5 is a flow chart illustrating a method of charging a power storage device by a photovoltaic voltage source in accordance with the present invention.

### DETAILED DESCRIPTION OF THE EMBODIMENTS

Embodiments of a battery charger in a solar panel powered energy system provided herein are characterized by bootstrap circuits for charging a bootstrap capacitor while the energy system is transitioning to a charging condition from an idle condition. Further, the battery charger operates in asynchronous mode till the photovoltaic current reaches a pre-defined threshold value.

The term ‘battery charger’ refers to a device and/or circuitry used for charging a power storage device. The term ‘battery’ and the phrase ‘power storage device’ are used herein interchangeably to denote standby power source that stores the solar energy. The phrase ‘charging circuit’ used herein refers to an electric circuit or a part of the battery charger circuitry that is used to providing charging current to the battery. The phrase ‘solar panel’ refers to photovoltaic energy converters configured to convert solar energy to electrical energy. The phrase ‘solar panel’ is used equivalently and interchangeably with the phrase ‘photovoltaic voltage source’. The term ‘power controller’ is used to refer to a device that includes devices and circuitry to implement maximum power point tracking (MPPT) technique of extracting power from the solar panels. The power controller also includes charging circuitry as disclosed in various embodiments of the present specification. Abbreviations ‘DC’ and ‘AC’ refer respectively to ‘direct current’ and ‘alternating current’ as conventionally used in the field of the present invention. The phrases ‘DC power’ and ‘AC power’ refer to power sources that provide DC current and voltages and AC current/voltages respectively. The phrase ‘bootstrap circuit’ used herein refers to a portion of the charging circuit that is used to charge a bootstrap capacitor. The phrase ‘bootstrap capacitor’ is used in the present specification to denote a capacitor in the battery charger circuitry that when charged helps in protecting the charging circuit. The phrase ‘idle condition’ refers to a state of the DC-to-DC converter typically after the dusk and before the dawn. The ‘idle condition’ may also refer to a condition of the battery charging circuit during the daytime when clouds reduce the charging current from the photovoltaic source below a pre-determined threshold. The phrase ‘idle condition’ is used interchangeably and equivalently with the phrase ‘idle state’ in the present specification. The phrase ‘push-pull configuration’ is used herein to represent a transistor configuration where the collector of the one transistor is connected to emitter of another transistor. The term ‘synchronous mode’ is used herein to indicate high efficiency mode where the both the transistors of the push-pull configuration are switched alternately. The phrase ‘asynchronous mode’ is used to indicate relatively lower efficiency mode where the bottom transistor of the push-pull configuration is operated as a diode and the upper transistor is operated as a switch. The DC-to-DC converter operating in the synchronous mode provides lower ripples and reduces the size of the capacitor in the converter circuit. The DC-to-DC converter operating in the asynchronous mode requires larger size capacitor and produces higher ripples. The phrase ‘boost mode’ is used to indicate the DC-to-DC converter operating to provide a higher voltage than the source voltage. The phrase ‘buck mode’ is used to indicate the DC-to-DC converter operating to provide a lower voltage than the source voltage.

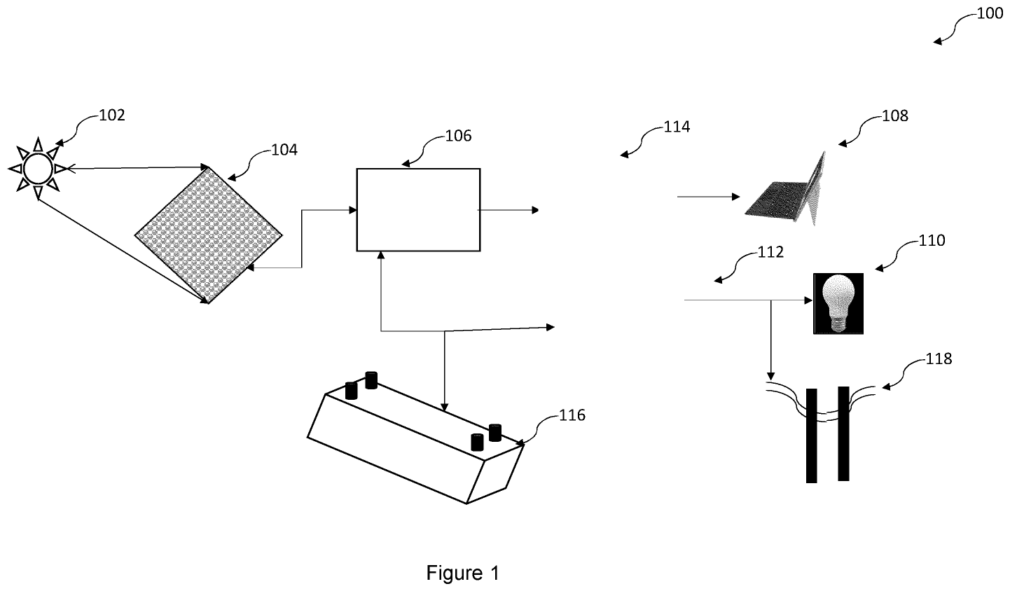

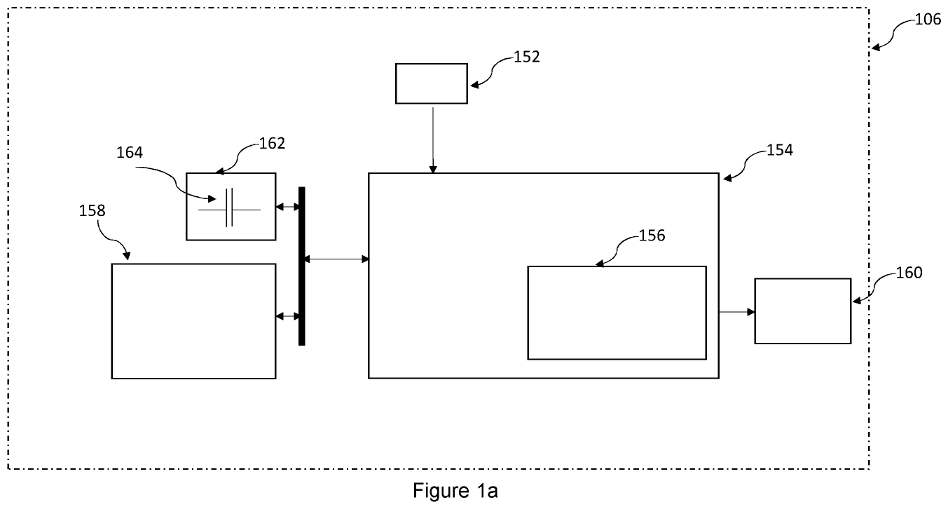

FIG. 1 depicts a solar powered energy system 100 with a battery charger in accordance with the present invention. The energy system 100 includes solar panel 104 illuminated by the sun 102. The solar panel 104 generates electric power which is extracted by a power controller 106 to generate direct current (DC) power. The power controller 106 typically is a maximum power point tracking (MPPT) controller used to optimize the power extraction from the solar panels. The DC power generated by the power controller 106 is provided to either a DC load 108 via a DC-to-DC converter 114 or as alternating current (AC) power to an AC load 110 via a DC-to-AC converter 112. The AC power generated by the DC-to-AC converter 112 may also be fed to an electric grid 118. The power controller 106 is also configured to provide charging current to electric storage unit 116 (battery). When the sun light is not available, and the electric storage unit 116 is charged, AC power may be generated using the DC-to-AC converter 112. It is also possible to support DC loads from the electric storage unit 116 via the DC-to-DC converter 114. The power controller 106 includes a charging circuitry (not shown in figure) that provides high efficiency without introducing negative current problem.

The power controller 106 in one embodiment may include one or more processors, one or more memory modules (not shown in the figure). The processor may be either a controller, a signal processor, a general purpose processor or a specialized processor configured to implement either one or more functionalities of the MPPT controller, the DC-to-DC converter, or the bootstrap circuit. The one or more memory modules may be a read only memory (ROM), a random-access memory (RAM), electrically programmable memory (EPROM) and a combination of them. The memory may include instructions to perform one or more functionalities of the power controller and the one or more processors may be configured to execute these instructions to process the electrical signals generated by the power controller or to provide control signals to various hardware elements such as transistors, MPPT controller, battery, and PV source. The one or more processors are configured to interact with other hardware elements such as, but not limited to, circuitry, components, and devices of the power controller 106.

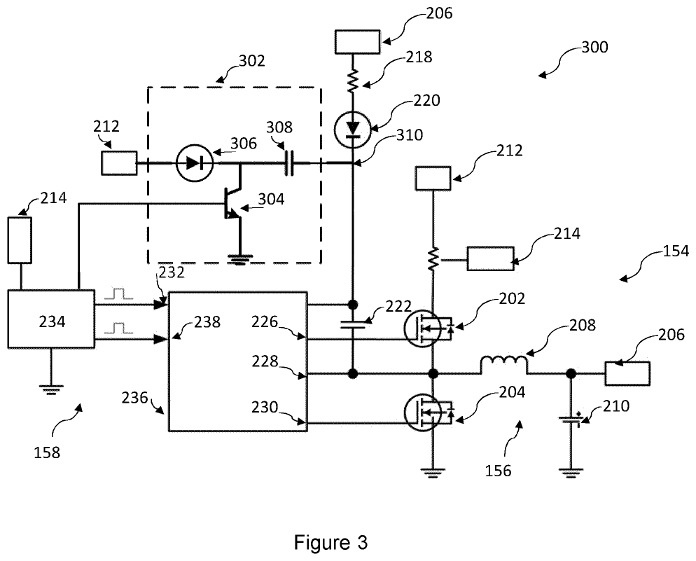

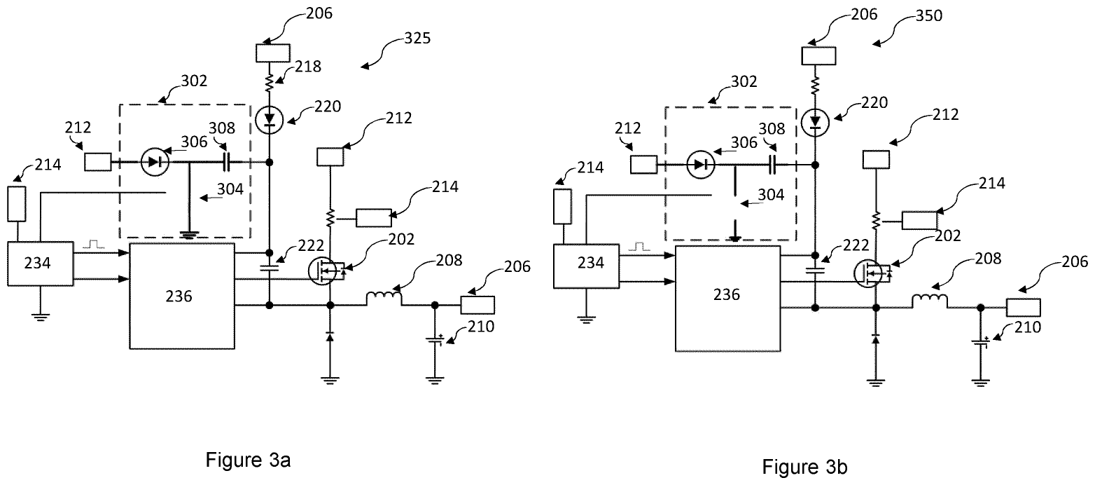

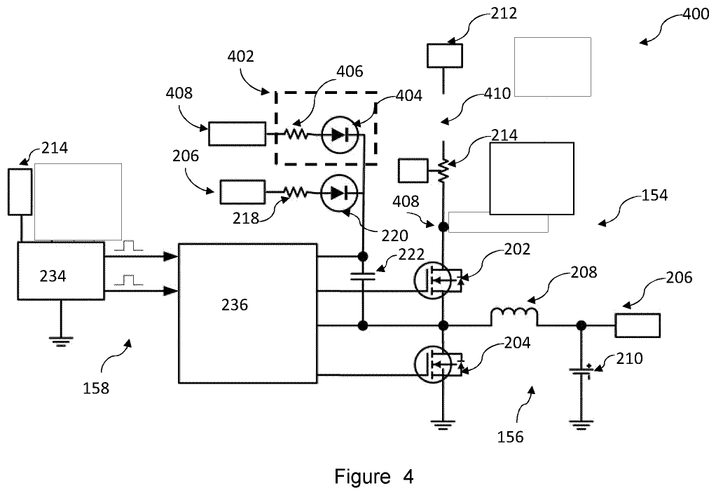

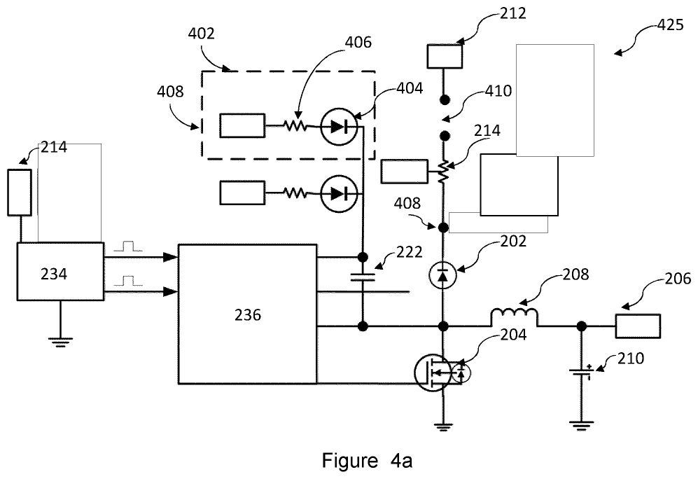

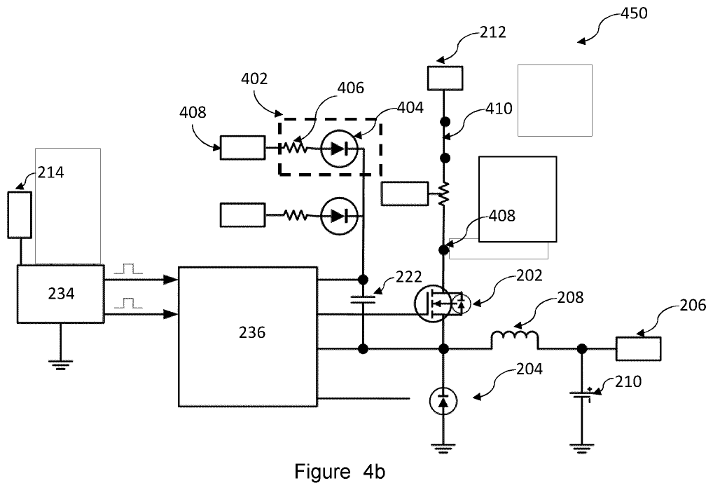

FIG. 1a illustrates a block diagram of the power controller 106 in accordance with the present invention. The block diagram 106 includes a photovoltaic (PV) voltage source 152 connected to a DC-to-DC converter 154. The DC-to-DC converter 154 among other components includes a charging circuit 156 to provide a charging current to an energy storage device 160. The block diagram 106 also includes a bootstrap circuit 162 comprising a bootstrap capacitor 164 and configured to prevent reverse current from the energy storage device 160 to the charging circuit 156 during transition from idle condition to the charging state of the DC-to-DC converter 154. The block diagram 106 also includes a control circuit 158 coupled to the bootstrap circuit 162 and the DC-to-DC converter 154 and configured to charge the bootstrap capacitor 164, operate the DC-to-DC converter 154 either in synchronous mode or in the asynchronous mode. In the subsequent figures, the photovoltaic (PV) voltage source 152 is represented by the reference numeral 212. The energy storage device 160 is represented by reference numeral 206. The bootstrap capacitor 164 is represented by reference numeral 222. The bootstrap circuit 162 is represented in FIG. 3 by reference numeral 302 and in FIG. 4 by reference numeral 402.

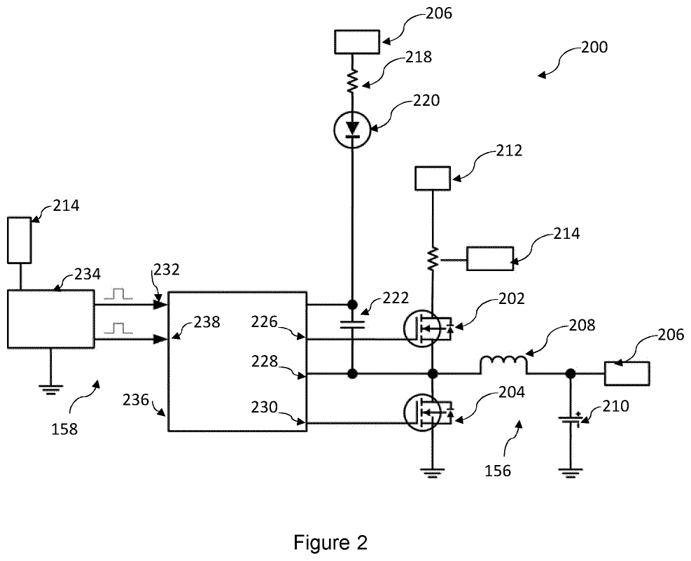

FIG. 2 depicts a conventional battery charging circuit 200 used in the power controller 106 of FIG. 1. The battery charging circuit 200 includes a high-side switch 202 and a low-side switch 204 connected to a photovoltaic (PV) voltage source 212 via a current sensing resistor 214. The current sensing resistor 214 is basically used to manage the charging current from the battery charging circuit 200. In one embodiment, the switches 202, 204 are Metal Oxide Semiconductor Field Effect Transistors (MOSFET). Preferably, the MOSFETs that are used for switches 202, 204 are N-channel type. It may be noted that N-channel MOSFETs are widely available with low price as compared to the P-channel MOSFETs. To turn on the N-channel MOSFETs, its gate to source voltage should be greater than the source voltage by a corresponding threshold voltage value. The circuit 200 further includes a MOSFET gate driver integrated circuit (IC) 236 coupled to the MOSFET switches 202, 204 and configured to provide corresponding gate signals. The circuit 200 also includes a microcontroller 234 coupled to the IC 236. The combination of the microcontroller 234 and the IC 236 is configured to provide complementary pulse width modulation (PWM) signals for driving the MOSFET switches 202, 204. The circuit 200 includes an electric storage unit 206 which is represented by reference numeral 116 in FIG. 1. The electric storage unit 206 is electrically coupled to the switches via a filter circuit having an inductor 208 and a capacitor 210. A bootstrapping capacitor 222 is provided in the circuit 200 to enable switching the high-side switch 202 to a conducting state. The bootstrap capacitor 222 is connected to the electric storage unit 206 via a current limiting resistor 218 and a series diode 220.

The configuration of MOSFET switches 202, 204 is also referred as ‘push-pull’ configuration in the literature. The push-pull configuration when operated in a complementary fashion, provides higher charging efficiency. In such an operation, the high-side switch 202 is turned on when the low-side switch 204 is turned off and the high-side switch 202 is turned off when the low-side switch 204 is turned on. Complementary switching of switches in the push-pull configuration is also termed as ‘synchronous operation’. Synchronous operation of the push-pull configuration in a buck mode is able to charge the electric storage unit 206. But, it may be noted that the push-pull configuration operating in the synchronous mode may also be used as a boost converter. During the start-up of the battery charging circuit 200, current is drawn from the electric storage unit 206 and the current is injected into the charging circuit towards the PV voltage source 212 in the boost mode. This condition is referred herein as ‘back-boosting’ and the boosted current from the electric storage unit 206 could damage the components in the charging path. The back-boosting condition can also occur during restart of the operation of the charging circuit after it is temporarily stopped. Interruptions in the operation of the charging circuit could happen due to multiple reasons such as, but not limited to, reduced sun light, and manual intervention. The state of the circuit 200 before start-up and restart is generally termed as ‘idle condition’. The back-boosting condition also occurs when the DC-to-DC converter is operating in a discontinuous conduction mode (DCM) as the low-side MOSFET can conduct in both directions during the DCM mode.

In some configurations of the prior art, a power diode is included in series with the electric storage unit 206. As the power diode conducts only in one direction, battery back-boosting is prevented. In an alternative configuration, a FET with a FET OR-ing controller is provided in between with the battery charging elements 208, 210. In yet another configuration, the push-pull configuration is operated in an asynchronous mode with the low-side MOSFET switched off. However, to initiate the battery charging from the idle condition, the low-side MOSFET has to be switched on at least temporarily opening up the possibility of occurrence of back-boosting. An isolated power supply may also be used to charge the bootstrapping capacitor 222 without turning the low-side MOSFET on. However, configurations used in the prior art are either expensive, or complex and does not solve the problem of back-boosting completely.

It may be noted that in this figure and also in subsequent figures, the components 214 (current sensing resistor), 202 (high-side switch) and 204 (low-side switch) are part of the DC-to-DC controller block 154 of FIG. 1a. The components 208 (inductor) and 210 (capacitor) are part of the charging circuit block 156 of FIG. 1a. Similarly, components 234 (microcontroller) and 236 (integrated circuit) are part of the control circuit 158 of the FIG. 1a.

FIG. 3 depicts a first embodiment of the charging circuit 300 used in the power controller 106 of FIG. 1 in accordance with the present invention. The charging circuit in this embodiment is enhanced version of the circuit 200 of FIG. 2. The charging circuit 300 includes a bootstrap circuit 302 modifying the conventional charging circuit. The bootstrap circuit 302 includes a transistor switch 304, a fast charging diode 306 and a charge pump ceramic capacitor 308. The fast charging diode 306 is coupled to the PV voltage source 212 and the ceramic capacitor 308 is connected to point 310 in between the bootstrap capacitor 222 and the series diode 220. The base of the bipolar junction transistor switch 304 is driven by the microcontroller 234, the collector of the transistor switch 304 is connected between the fast charging diode 306 and ceramic capacitor 308. The emitter of the transistor switch 304 is grounded.

When the charging circuit 300 is in the idle condition, the controller 234 may be used to provide switching signals to the transistor switch 304 to charge the ceramic capacitor 308 to a voltage provided by the electric storage unit 206. In a further step, the controller 234 provides control signal to the transistor switch 304 to provide a discharging path from the PV voltage source 212 towards the electric storage unit 206 via the bootstrap capacitor 222. This enables charging the bootstrap capacitor 222 to open source voltage of the PV voltage source 212. Charge of the bootstrap capacitor 222 is clamped by a circuit (not shown in the figure) such as, but not limited to, a Zener diode and a resistor. The clamping voltage is maintained at gate to source voltage of the high-side MOSFET. After the bootstrap capacitor 222 is charged, the driver IC 236 provides sufficient voltage to the gate of high-side switch 202 to change its state to the conducting state. The controller 234 provides a waveform with an appropriate duty-cycle so that the push-pull configuration operates in asynchronous mode. The solar charging is performed by using MPPT technique during the asynchronous mode. The PV current increases in the circuit and when it reaches 60% of the maximum PV current supported by the hardware limitations, the charging circuit is ready to be operated in synchronous mode. The controller 234 is configured to turns the low-side MOSFET to the ON condition and the charging circuit operates in the synchronous mode.

FIG. 3a and FIG. 3b depict the operation of the bootstrap circuit 300 of FIG. 3 in accordance with the present invention. FIG. 3a illustrates charging path for the ceramic capacitor 308 when the charging circuit is operated from the idle condition. The transistor switch 304 is in conducting state providing a charging path to the capacitor 308 from the power storage device 206 via the current limiting resistor 218 and the series diode 220. In one embodiment, the charging path is established for a short duration of 100 milliseconds.

FIG. 3b illustrates charging path for the bootstrap capacitor 222 when the transistor switch 304 is operated in non-conducting state. In such a configuration, the bootstrapping capacitor 222 is charged from the PV voltage source 212 via diode 306, the capacitor 308, the inductor 208 and the power storage device 206.

FIG. 4 depicts a second embodiment of the charging circuit 400 used in the power controller 106 of FIG. 1 in accordance with the present invention. The charging circuit in this embodiment is enhanced version of the charging circuit 200 of FIG. 2. The charging circuit 400 includes the basic configuration of the charging circuit of FIG. 2 with exemplary modifications as explained herein. The circuit 400 includes a bootstrap circuit section 402 connected in parallel to the path that includes the current limiting resistor 218 and the series diode 220. The bootstrap section 402 is provided with a voltage source 408 derived by switching off the high-side MOSFET and switching on the low-side MOSFET when the PV voltage source is open circuited by switch 410. The voltage source 408 is used to charge the bootstrap capacitor 222 via the bootstrap circuit section 402. The bootstrap section 402 includes a resistor 406 and a forward biased diode 404 connected in series with the bootstrap capacitor 222. The push-pull configuration is configured to operate in a boost mode to provide a higher voltage 408 from the power storage device 206. It may be noted that the push-pull configuration is operated in asynchronous manner while generating the voltage 408 in the boost mode. The voltage 408 is maintained at a level which is sufficient to charge the bootstrap capacitor 222. Once the bootstrap capacitor 222 is charged, the push-pull configuration may be operated first in asynchronous mode to charge the power storage device 206 from the PV voltage source 206 when the photovoltaic charging current is small. It may be noted that the asynchronous mode of operation generates a buck voltage. As the photovoltaic charging current increases beyond a pre-determined threshold value, the push-pull configuration is operated in a synchronous buck mode to charge the power storage device 206 from the PV voltage source 206.

FIG. 4a, and FIG. 4b depict the operation of the charging circuit 400 of FIG. 2 in accordance with the present invention. FIG. 4a illustrates the charging circuit operating in a boost mode. The high-side switch 202 is operated as a forward biased diode from the power storage device 206 towards the photovoltaic source 212. When the charging circuitry is operated in the boost mode starting from the idle condition, the photovoltaic source 212 is disconnected and the switch 202 is operated as the diode. A boost voltage 408 is generated when the push-pull configuration is operated in the boost mode. The boost voltage 408 is higher than the voltage of the power storage device 206 by forward diode voltage. In one embodiment, when the battery voltage is 24 Volts, the boost voltage 408 is at 36 volts. When the voltage 408 is reached at the boost mode, the bootstrap circuit section 402 enables charging of the bootstrap capacitor 222 to the bootstrap voltage. Charging of the bootstrap capacitor further enables operating the push-pull configuration in an asynchronous buck mode.

FIG. 4b illustrates the charging circuit operating in an asynchronous buck mode. This mode is selected by the microcontroller 234 when the bootstrap capacitor 222 is charged. The high-side switch 202 is switched on and the low-side switch 204 is switched off by applying suitable gate to source voltages to the respective switches 202, 204. The photovoltaic voltage source 212 is connected to the charging section and the battery is charged in asynchronous buck mode. Subsequently, when the charging current increases beyond a pre-determined threshold value, the low-side switch 204 may also be switched alternatively with the high-side switch 202 to operate the charging circuit in synchronous mode.

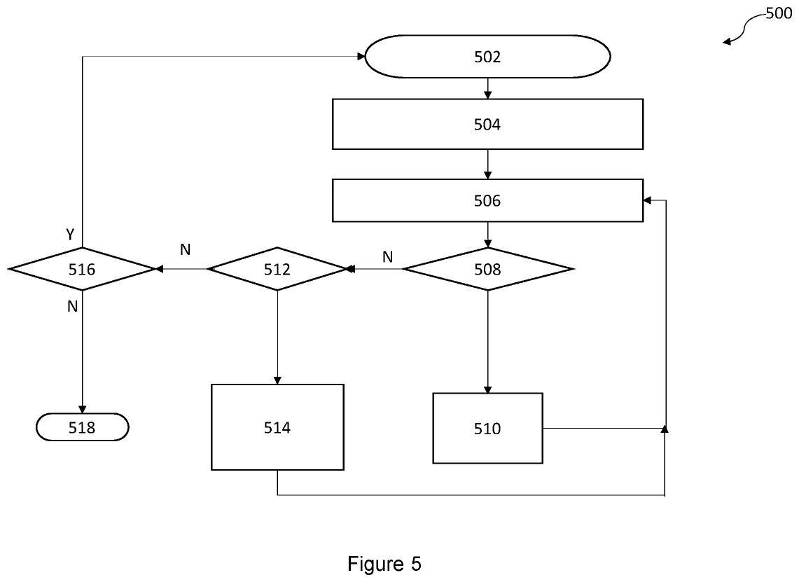

FIG. 5, is a flow chart illustrating a method 500 of charging a power storage device 206 by a photovoltaic voltage source 212 in accordance with the present invention. The method 500 is initiated from an idle condition of step 502. As stated previously, the phrase ‘idle condition’ refers to a condition of the charging circuit either at the dawn or during the day when the charging current is reduced below a pre-determined threshold suitable for charging. In such a condition, the photovoltaic voltage source 212 is disconnected from the charging circuit and the charging is stopped. When the charging is to be resumed from the idle condition, before connecting the photovoltaic voltage source 212 to the charging circuit, the bootstrap capacitor is to be charged. In one embodiment, bootstrap capacitor 222 is charged by a bootstrapping circuit section 302 having a diode, transistor, and a ceramic capacitor combination. In another embodiment, the bootstrap capacitor 222 charged using a bootstrapping circuit section 402 having a diode and resistor combination operated by a boosted voltage source. The step of charging the bootstrap capacitor is illustrated in step 504. After the charging of the bootstrap capacitor 222, the charging circuit may follow maximum power point tracking (MPPT) technique to derive optimum power from the photovoltaic voltage source 212 as shown in step 506. The charging method 500 further includes verifying the value of charging current at step 508. When the charging current is less than a predetermined threshold value, the method 500 includes operating push-pull switches of the charging circuit in an asynchronous mode as shown in step 510. Further, when the charging current exceeds the pre-determined threshold value, such a condition is verified at step 512 and the push-pull switches of the charging circuit is operated in synchronous mode as illustrated in step 514. The charging circuit continues to operate in the synchronous mode till either the power storage device is fully charged or when the charging circuit reaches an idle condition. These conditions are determined at step 516. When the power storage device is fully charged, the charging is stopped and the method 500 is concluded as in step 518. When the charging circuit enters an idle condition, the charging is stopped, and the charging circuit stays in the idle condition illustrated by step 502.

It is to be understood that not necessarily all such objects or advantages described above may be achieved in accordance with any particular embodiment. Thus, for example, those skilled in the art will recognize that the components and configurations of the battery charger described herein may be embodied or carried out in a manner that achieves or improves one advantage or group of advantages as taught herein without necessarily achieving other objects or advantages as may be taught or suggested in the present specification.

While the battery charger has been described in detail in connection with only a limited number of embodiments, it should be readily understood that the specification is not limited to such disclosed embodiments. Rather, the battery charger can be modified to incorporate any number of variations, alterations, substitutions, or equivalent arrangements not heretofore described, but which are commensurate with the spirit and scope of the claims. Additionally, while various embodiments of the battery charging system have been described, it is to be understood that aspects of the specification may include only some of the described embodiments. Accordingly, the specification is not to be seen as limited by the foregoing description but is only limited by the scope of the appended claims.

1. A battery charger comprising:
a DC-to-DC converter comprising a charging circuit and configured to receive an input from a photovoltaic power source and provide a charging current to an energy storage device via the charging circuit;
a bootstrap circuit configured to charge a bootstrap capacitor enabling prevention of reverse current from the energy storage device to the charging circuit during transition from idle condition to the charging state of the DC-to-DC converter;
a control circuit coupled to the bootstrap circuit and the DC-to-DC converter and configured to:
charge the bootstrap capacitor using the bootstrap circuit for a first time duration (or to a first voltage value) when the DC-to-DC converter is in the idle condition;
operate the DC-to-DC converter in asynchronous mode immediately after the first time duration or the first voltage value to charge the energy storage device when the charging current to the energy storage device is less than a first current value; and
operate the DC-to-DC converter in synchronous mode from the asynchronous mode when the charging current to the energy storage device reaches the first current value.

2. The battery charger of claim 1, wherein the bootstrap circuit comprises:
a diode in series with a first capacitor connected between the photovoltaic power source and the energy storage device;
a transistor switch coupled to the first capacitor and configured to provide a charging path from the energy storage device to the first capacitor, wherein the transistor switch is coupled to the photovoltaic power source and configured to provide a second charging path to the energy storage device.

3. The battery charger of claim 2, wherein the control circuit is configured to switch on the transistor switch during the idle condition for the first time duration.

4. The battery charger of claim 1, wherein the first duration is about 100 milliseconds and wherein the first current value is about 60% of the rated current of the photovoltaic power source.

5. The battery charger of claim 1, wherein the bootstrap circuit comprises:
a resistor and a diode connected in series between input terminal of the DC-to-DC converter and the bootstrap capacitor and configured to provide a charging path from the input terminal to the bootstrap capacitor during the idle condition.

6. The battery charger of claim 5, wherein control circuit is configured to operate the DC-to-DC converter in a boost mode to generate the boost voltage at the input terminal of the DC-to-DC converter.

7. The battery charger of claim 1, wherein the DC-to-DC converter comprises a high-side transistor and a low-side transistor arranged in a push-pull transistor configuration.

8. The battery charger of claim 1, wherein the control circuit is configured to operate the high-side transistor as a switch and the low-side transistor as a diode to provide rectifying action in the asynchronous mode.

9. The battery charger of claim 1, wherein the control circuit is configured to operate the high-side transistor and the low-side transistor as switches to provide rectifying action in the synchronous mode.

10. A battery charging method, comprising:
operating a bootstrap circuit when a DC-to-DC converter is in idle condition to charge a bootstrap capacitor for a first time duration or to a first voltage value;
operating the DC-to-DC converter in an asynchronous mode immediately after the first time duration or the first voltage value to charge the energy storage device when the charging current to the energy storage device is less than a first current value; and
operating the DC-to-DC converter in synchronous mode when the charging current to the energy storage device reaches the first current value.

11. The method of claim 10, wherein operating the bootstrap circuit comprises charging the bootstrap capacitor by switching on a transistor switch of the bootstrap circuit.

12. The method of claim 10, wherein operating the bootstrap circuit comprises charging the bootstrap capacitor by a boost voltage via a resistor and a diode connected in series with the bootstrap capacitor.

13. The method of claim 10, wherein the first time duration is about 100 milliseconds and wherein the first current value is about 60% of the rated current of the photovoltaic power source.

14. The method of claim 10, wherein operating the DC-to-DC converter in an asynchronous mode comprises operating a high-side transistor as a switch and a low-side transistor as a diode to provide rectifying action in the asynchronous mode.

15. The method of claim 10, wherein operating the DC-to-DC converter in a synchronous mode comprises operating the high-side transistor and the low-side transistor as switches to provide rectifying action in the synchronous mode.
